(19) United States
(12) Patent Application Publication
(10) Pub. No.: US 2005/0192725 A1
(43) Pub. Date: Sep. 1, 2005

(54) Auxiliary visual interface for vehicles

(76) Inventor: Shih-Hsiung Li, Taipei (TW)

Correspondence Address: Troxell Law Office PLLC, Suite 1404, 5205 Leesburg Pike, Falls Church, VA, 22041, US

(21) Appl. No.: 10/788,286

(22) Filed: Mar. 1, 2004

(51) Int. Cl. G06F 19/00; G06G 7/78

(52) U.S. Cl. 701/36; 701/301; 348/148; 340/436

(57) ABSTRACT

An auxiliary visual interface for a vehicle is disclosed, which is designed to expand the traffic view of the driver beyond the driver compartment. The visual interface consists of four video cameras respectively installed at four corners of the vehicle. Through two switching elements, video images from the front-end or rear-end video cameras are simultaneously brought onto two LCD displays arranged on the dash board to enable the driver to preview the traffic conditions around the corner before making the turn or backing out of an alley. The main controller can also be connected to a speed recorder, whereby the upper and lower speed limits are preset to control different display modes. The main controller can also be connected to a back-up detector to measure the relative distance of any object approaching from behind. The present invention promotes driving safety on the road.

### BACKGROUND OF THE INVENTION

1. Field of the Invention

The present invention is related to an auxiliary visual interface for drivers of vehicles, and more particularly to a multi-media monitoring apparatus that enables the driver of a passenger vehicle to expand the view through simultaneous display of the traffic conditions in front and behind the vehicle.

2. Description of Related Art

In the past, the driver of a vehicle solely relied on the rear view mirror and left/right side mirrors to monitor the traffic conditions behind and on the lateral sides of the vehicle. But there were certain situations that the driver's view was blocked by either the vehicle body or obstacles, and had to rely on own driving experience to make the maneuver, for instance, taking a turn from or backing out of a small alley, switching lane on a super highway, and parking along a roadside curb, which could be unsafe moments for inexperienced drivers.

Nowadays, many electronic driving aids are available to the driving public. Drivers of passenger vehicles may use a back-up detector to help them in parking or backing up in small alleys. Large vehicles such as truck trailers and tour buses, because of their extended length, may have CCD cameras installed at the rear-end of their vehicles to allow the drivers to monitor the road and traffic conditions from behind.

However, the conventional electronic devices can no longer satisfy the ever-increasing demand of consumers. In many difficult driving conditions, even though vehicles are equipped with electronic devices, the vehicle drivers still have to rely on their own vision and experience to monitor the traffic conditions.

As in FIG. 5, a vehicle coming out from a small alley or making a blind turn, the driver is unable to see the traffic conditions around the corner that the vehicle is to turn. If a second vehicle happens to approach from the opposite side at a right angle, the driver in the first vehicle could miss the second vehicle, and the driver in the second vehicle could be caught by surprise when the first vehicle pulls out from the alley. Situations like this could lead to serious accidents.

There may be magnifying mirrors posed at the blind turn corners to allow drivers to see the traffic coming from the other side. But the fact that the driver compartment of a passenger vehicle is often designed to be in the middle section of the vehicle, the driver's view is completely blocked in situations like small alleys, parking lots, blind corners, and in usual blind pockets behind the vehicle. As the traffic conditions on the other side of the road are largely unnoticed, any move by the driver, who intends to make a turn or back out, will run the risk of collision with any vehicles on the other side.

As in FIG. 6, for instance, when the vehicle (70) backs out from a parking lot, the driver of the vehicle (70) conventionally relies on the left/right side mirrors (71) (72) to monitor the traffic conditions behind the vehicle. As the view of the driver (slash lines) through the left/right side mirror (71) (72) of the vehicle (70) is blocked by adjacent vehicles, any vehicle approaching from the other side will not be detected by the driver in the first vehicle (70).

### SUMMARY OF THE INVENTION

The main object of the present invention is to provide an auxiliary visual interface that enables the driver to preview the traffic conditions around the corner before the vehicle actually makes the turn, and such early information also give the driver extra time to prepare for any situation.

To this end, the auxiliary visual interface in accordance with the present invention comprises:
four video cameras, respectively installed at four corners, left front, right front, left rear, and right rear, of the vehicle to capture images from different angles;
two LCD displays, respectively installed on two sides of the dash board, for continuous presentation of images captured by the video cameras;
two switching elements, each having one output and two inputs, wherein the outputs are connected to the respective LCD displays, and the inputs of the first switching element are connected to the pair of left front and left rear video cameras, and the inputs of the second switching element are connected to the pair of right front/right rear video cameras; and
a main controller, being connected to all four video cameras and two switching elements, whereby the main controller controls the video output on two LCD displays through the switching elements.

According to the present design, the video cameras are strategically installed at four corners of the vehicle for wide angle view of the traffic and road conditions. These video cameras enable the driver to expand the traffic view beyond the driver compartment. Since the driver compartment of a passenger vehicle is conventionally designed to be in the middle section of the vehicle, the driver's angle of view will be severely blocked if the vehicle is located in small alleys or sandwiched in among tall structures.

The driver of the vehicle equipped with the auxiliary visual interface can operate through the main controller to cause the switching element to bring on the front-end or rear-end video cameras to monitor the traffic conditions with a wide angle view.

When the driver is about to make a turn, the video cameras allow the driver to preview the road and traffic conditions in the direction that the vehicle is about to make the turn. This gives the driver more time to prepare for any vehicle approaching from the other side or pedestrians crossing the road. Thus, effective use of the auxiliary visual interface can promote driving safety on the road.

The main controller can be further connected to a speed recorder, whereby the upper and lower speed limits can be preset for control of display modes. If the vehicle speed drops below the lower speed limit, the main controller initiates the video cameras in front of the vehicle to monitor the traffic conditions in front and on two sides of the vehicle. If the vehicle speed is over the upper speed limit, the video cameras on the rear end of the vehicle are initiated to monitor the traffic conditions behind the vehicle.

The main controller can be further connected to back-up detectors to measure the relative distance from any object when the vehicle is in the reverse gear.

Other objectives, advantages and novel features of the invention will become more apparent from the following detailed description when taken in conjunction with the accompanying drawings.

### BRIEF DESCRIPTION OF THE DRAWINGS

FIG. 1 is a block diagram of the system architecture of the present invention;

FIG. 2 is a diagram of the arrangement of two LCD displays on the dashboard;

FIG. 3 shows the wide angle view (slash lines) of front-end video cameras when the vehicle is about to make a turn from a small alley;

FIG. 4 shows the view (slash lines) of rear-end video cameras when the vehicle backs out from a parking lot;

FIG. 5 shows the usual view (slash lines) of a driver when the vehicle arrives at a street corner and is about to make a turn; and

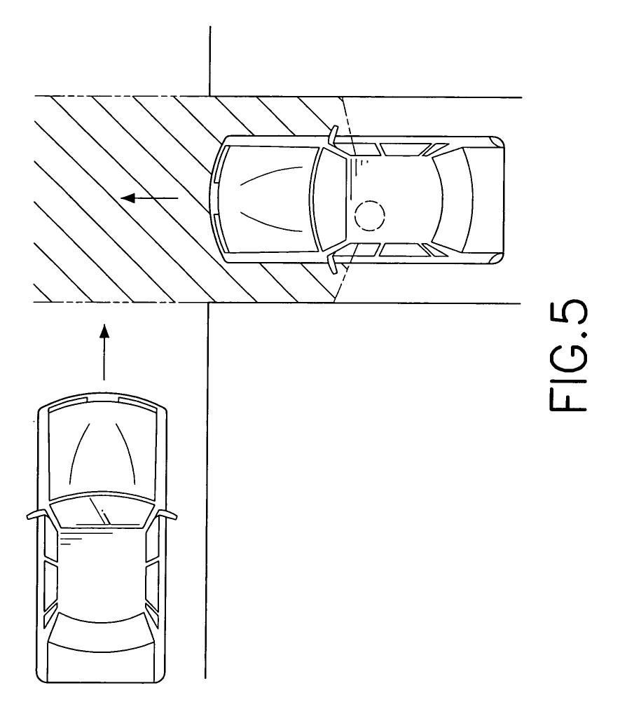

FIG. 6 shows the usual view (slash lines) of a driver when the vehicle is about to back out from a parking lot.

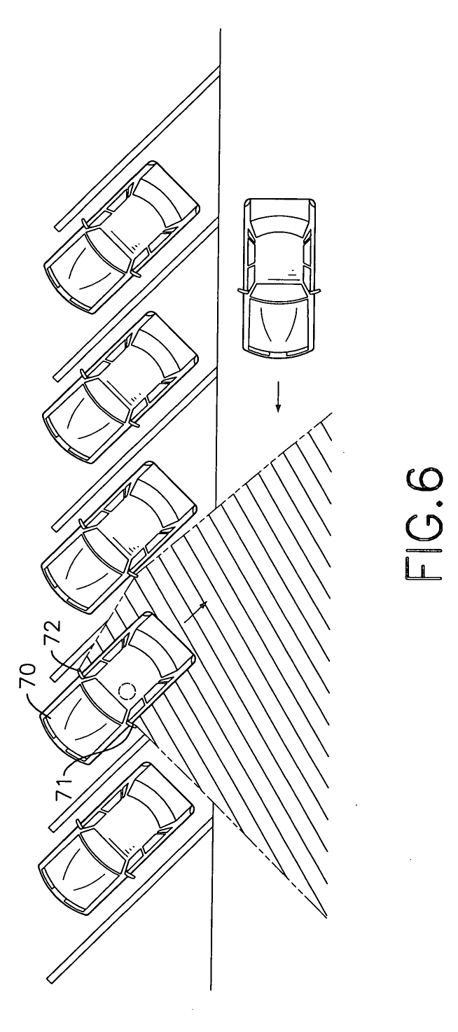

### DETAILED DESCRIPTION OF THE PREFERRED EMBODIMENT

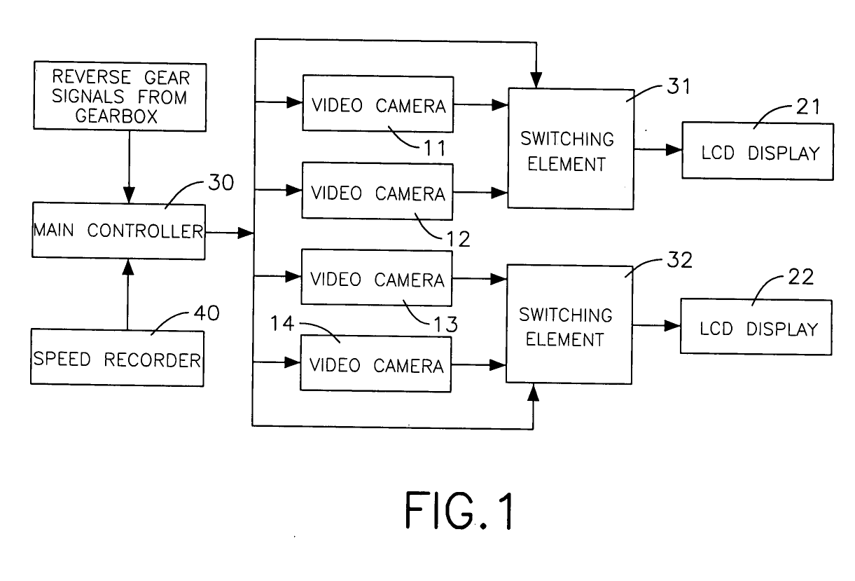

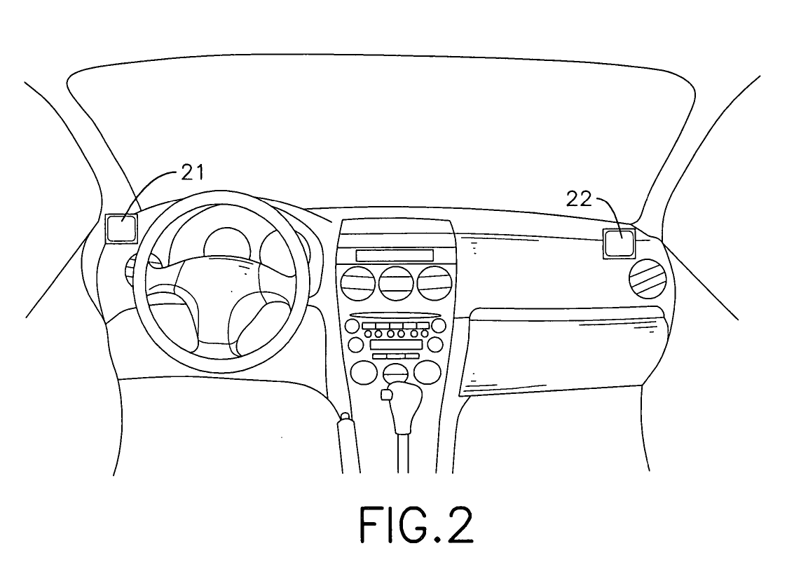

The structure of the present invention is described through a preferred embodiment, as shown in FIG. 1, comprising:
four video cameras (11-14), being respectively installed at four corners, left front, right front, left rear, and right rear, of the vehicle, in the front and at the back of the driver compartment, wherein the video cameras are installed inside the holder of the headlights and taillights, on outside corners and diagonally oriented, for capturing wide angle video images; and the video cameras (11-14) can be CCDs or CMOS image sensors;
two LCD displays (21) (22), being fixed on two sides of the dash board (shown in FIG. 2), wherein one LCD display (21) controls the video images from the left front and left rear video cameras (11) (12), and the other LCD display (22) controls video images from the right front and right rear video cameras (13) (14);
two switching elements (31) (32), each having one output and two inputs, wherein the outputs are connected to the respective LCD display (21) (22), and the inputs of the first switching element (31) are connected to the pair of left front and left rear video cameras (11) (12), and the inputs of the second switching element (32) are connected to the pair of right front and right rear video cameras (13) (14);
a main controller (30), being connected to all four video cameras (11-14) and the two switching elements (31) (32), wherein the main controller (30) controls the video output on the two LCD displays (21) (22) through the switching elements (31) (32); and
a speed recorder (40), also being connected to the main controller (30), for instantaneous recording of the vehicle speed when the vehicle is in motion.

The four video cameras (11-14) are installed inside the holders of the headlights and taillights, towards the outside corners and diagonally oriented, whereby the four video cameras (11-14) obtain wide angle views of the traffic conditions in front and at the back of the vehicle. The video images are simultaneously presented on the LCD displays (21) (22), allowing the driver to preview the traffic conditions around the corner before taking a turn or to monitor the road conditions during normal driving or moving in the reverse direction.

When the vehicle is about to make a turn from an intersection, the front-end video cameras (11) (13) capture images around the corner before the vehicle actually makes the turn. When the vehicle backs out of a parking space or an alley, the rear-end video cameras (12) (14) obtain wide angle views around the corner where the driver's view is blocked.

The first switching element (31) is used to control the left-side video display (21) from left front and left rear video cameras (11) (12), while the second switching element (32) controls the right-side video display (22) from the right front and right rear video cameras (13) (14), so that the driver is able to monitor the road conditions in front, at the back, as well as on two sides of the vehicle.

The auxiliary visual interface also works in conjunction with a speed recorder (40), which is used to record the vehicle speed when the vehicle is in motion. The upper and lower speed limits can be preset. Basing on the speed data fed by the speed recorder (40), the main controller (30) issues instructions to the two switching elements (31) (32) to switch to the appropriate video display modes.

For instance, the lower speed limit can be set to be 10 km/h as in the present example. When the vehicle speed is below 10 km/h, the system assumes that the vehicle is approaching an intersection or encountering heavy traffic. Accordingly, the main controller (30) orders the switching elements (31) (32) to turn on the left front and right front video cameras (11) (13) through the two LCD displays (21) (22) to allow the driver to monitor the traffic situation in front and on two sides of the vehicle.

If the vehicle is below 10 km/h, and the vehicle is in reverse gear, the main controller (30) orders the switching elements (31) (32) to turn on the left rear and right rear video cameras (12) (14) through the two LCD displays (21) (22).

The upper speed limit can be set to be 50 km/h as in the present example. If the vehicle speed is over 50 km/h and the vehicle is moving in the forward direction, the main controller (30) orders the switching elements (31) (32) to turn on the left rear and right rear video cameras (12) (14) through the two LCD displays (21) (22) to allow the driver to monitor the traffic situation behind and on two sides of the vehicle.

The main controller (30) routinely checks for the left and right signal lights, basing on which the main controller (30) orders the switching elements (31) (32) to bring on the front-end video cameras (11) (13).

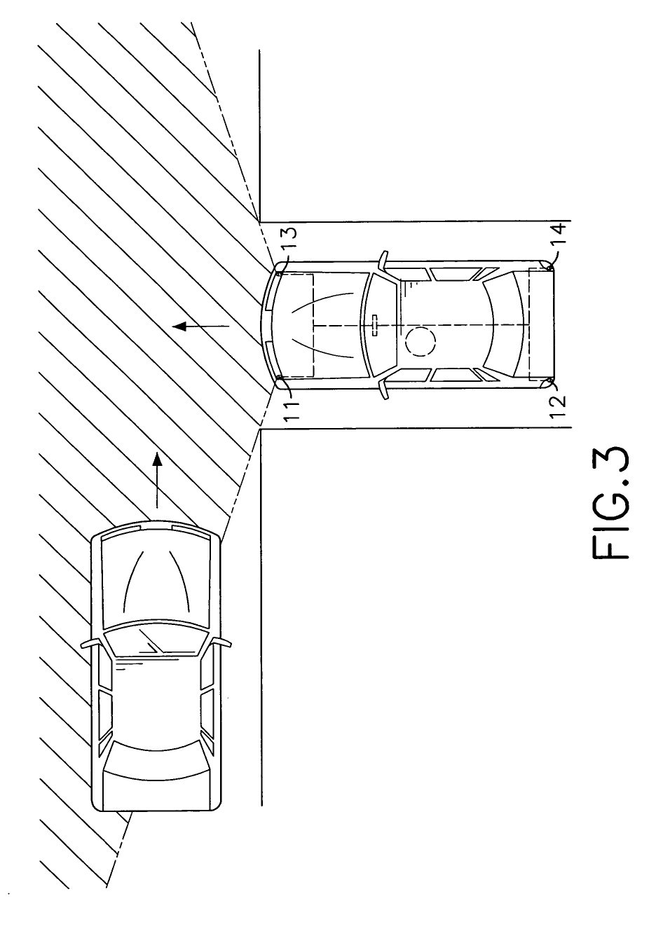

As shown in FIG. 3, when the vehicle enters an intersection, the left front and right front video cameras (11) (13) are initiated to capture wide angle views (slash lines) in front of the vehicle. If another vehicle approaches from the left front direction, the left front video camera (11) captures the image of the vehicle and the images are simultaneously presented over the LCD display (21). The driver is therefore informed of a vehicle approaching from the left front corner and becomes more aware.

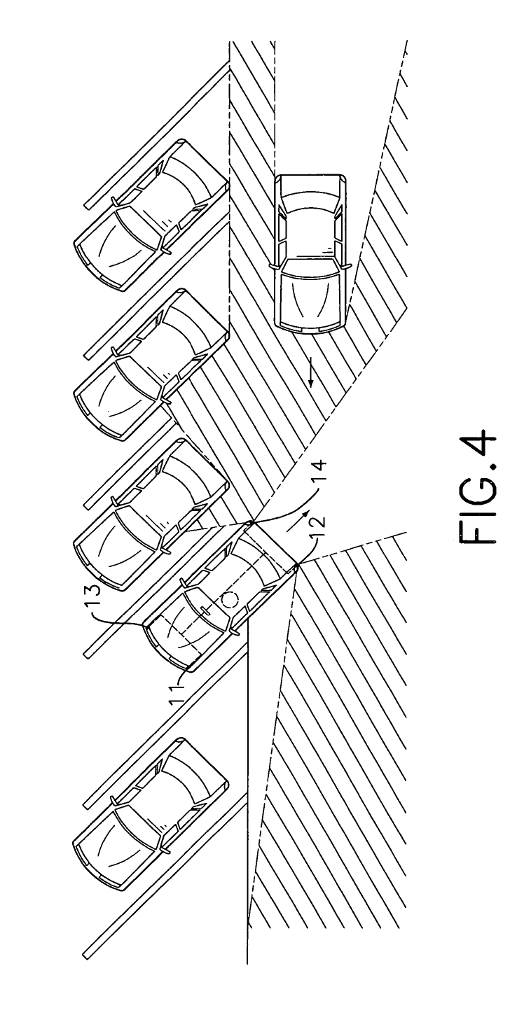

As shown in FIG. 4, when the vehicle backs out of a parking lot, the left rear and right rear video cameras (12) (14) are initiated. The cameras capture the traffic view (slash lines) from the left rear and right rear corners of the vehicle. If a vehicle approaches from the right rear direction, the right rear video camera (14) captures the image of the vehicle and the images are shown on the LCD display (22). The driver then knows that a vehicle is approaching from the right rear corner.

The main controller (30) can be further connected to several back-up detectors, whereby the main controller (30) checks for any objects approaching from behind when the vehicle is in reverse gear and turns on the rear-end video cameras (12) (14) through the switching elements (31) (32).

From the foregoing, the present invention provides a multi-media monitoring system consisting of several video cameras, a speed recorder and several back-up detectors. The video cameras enable the driver to preview the traffic conditions around the corner before the vehicle actually makes a turn, or backs out from a parking lot or alley. Also, the rear-end video cameras can also be used to monitor the traffic behind the vehicle during high speed driving. Thus, effective use of the multi-media system can promote driving safety on the road.

It is to be understood, however, that even though numerous characteristics and advantages of the present invention have been set forth in the foregoing description, together with details of the structure and function of the invention, the disclosure is illustrative only, and changes may be made in detail, especially in matters of shape, size, and arrangement of parts within the principles of the invention to the full extent indicated by the broad general meaning of the terms in which the appended claims are expressed.

1. An auxiliary visual interface for a vehicle, comprising:
four video cameras (11-14), being respectively installed at four corners of the vehicle, left front corner, right front corner, left rear corner and right rear corner, to capture video images around the vehicle;
two LCD displays (21) (22), being fixed on two sides of a dash board of the vehicle, to present video images captured by the video cameras (11-14);
two switching elements (31) (32), each having one output and two inputs, wherein the outputs are connected to respective LCD displays (21) (22), and the inputs of the first switching element (31) are connected to a pair of left front and left rear video cameras (11) (12), while the inputs of the second switching element (32) are connected to a pair of right front and right rear video cameras (13) (14); and
a main controller (30), being connected to all the four video cameras (11-14) and the two switching elements (31) (32), to control video output through the switching elements (31) (32).

2. The auxiliary visual interface according to claim 1, wherein the main controller (30) is further connected to a speed recorder (40).

3. The auxiliary visual interface according to claim 1, wherein the main controller (30) is further connected to a back-up detector.

4. The auxiliary visual interface according to claim 1, wherein the video cameras (11-14) are CCD cameras.

5. The auxiliary visual interface according to claim 1, wherein the video cameras (11-14) are CMOS image sensors.

6. The auxiliary visual interface according to claim 3, wherein the main controller (30) is to use output signals of the back-up detector to control video output from the rear-end video cameras (12) (14) through the switching elements (31) (32).

7. The auxiliary visual interface according to claim 1, wherein the main controller (30) is to use signals from left and right turn lights to control video output from the front-end video cameras (11) (13) through the two switching elements (31) (32).

8. The auxiliary visual interface according to claim 2, wherein the main controller (30) is to use signals from the speed recorder (40) to control video output from the front-end video cameras (11) (13) through the switching elements (31) (32).

9. The auxiliary visual interface according to claim 2, wherein the main controller (30) is to use the signals from the speed recorder (40) to control video output from the rear-end video cameras (12) (14) through the switching elements (31) (32).

10. The auxiliary visual interface according to claim 1, wherein the main controller (30) is to use reverse gear signals from a gearbox of the vehicle to control video output from the rear-end video cameras (12) (14) through the switching elements (31) (32).

11. The auxiliary visual interface according to claim 1, wherein the four video cameras (11-14) are installed inside holders of headlights and taillights of the vehicle, towards outside corners and diagonally oriented, whereby the cameras (11-14) are able to capture wide angle views of the traffic conditions.
